(19) United States
(12) Patent Application Publication
(10) Pub. No.: US 2004/0199408 A1
(43) Pub. Date: Oct. 7, 2004

(54) Medical information card

(76) Inventor: Tolbert R. Johnson, Fairburn, GA (US)

Correspondence Address: LITMAN LAW OFFICES, LTD., P.O. BOX 15035 CRYSTAL CITY STATION, ARLINGTON, VA, 22215, US

(21) Appl. No.: 10/403,043

(22) Filed: Apr. 1, 2003

(51) Int. Cl. G06F 17/60

(52) U.S. Cl. 705/3

(57) ABSTRACT

The medical information card is a card which may be carried by a patient, e.g., in the patient's wallet, and includes pertinent information about the patient's medical history and current medications in a form which is readable without the use of a machine. A computerized system and method for producing the card includes a database maintained by or accessible by the pharmacy, and by the patient through the Internet. When the patient visits the pharmacy with a new prescription, the database is updated to include the new prescription and a new or replacement medical information card is printed out and provided to the patient.

### BACKGROUND OF THE INVENTION

1. Field of the Invention

The present invention relates to a computerized system and method for providing a medical information card. More specifically, the present invention is a system and method for providing a medical information card that lists the prescription drugs that a patient is currently taking along with other useful medical information about the patient.

2. Description of the Related Art

In the healthcare industry, one of the most common questions put to a patient is what medications the patient is currently taking. During any visit to a doctor's office a patient may be asked about his medications. Whenever a new medication is prescribed, an accurate answer may be essential to avoid a dangerous drug interaction. Patients are often unaware of, or have difficulty in recalling, all of the relevant information about their prescription medications, such as the names of prescribed drugs, the prescribed dosages, and even the reasons that various drugs were prescribed. When a patient sees only one doctor, this problem may be alleviated by the information contained in the patient's file maintained by the doctor's office. However, when a patient sees numerous doctors and other health-care providers, medical records are usually not shared among the separate offices. In such cases it is up to the patient to provide this information, or up to one office to contact another to track this information down. If the patient cannot recall his medication information, it may be a difficult or fruitless task for the doctor to gather the information from the other doctors that the patient sees. It is important for a patient to have an up-to-date and accurate record of their prescription and other medications, along with other general medical information, such as the names and telephone numbers for their doctors and other healthcare services.

Various devices and systems have been developed to record patient medical history and information in a form that may be carried by the patient. Many such devices and systems are tailored to alerting emergency healthcare responders to a particular condition, such as diabetes or an allergy that may require a specific and immediate response.

U.S. Pat. No. 3,958,690, issued on May 25, 1976 to R. W. Gee, Sr., discloses a medical identification, information, and emergency medication packet that includes an identification card indicating a particular medical condition along with emergency contact information. The card also describes various symptoms of an acute attack, and appropriate steps to be taken for treatment. Along with the card, the packet includes a small supply of a medication for emergency treatment of the condition.

The medical alert card described by U.S. Design Patent No. 396,882, issued on Aug. 11, 1998 to R. Neal, Jr., includes a checklist of various medical conditions. A patient carrying the card marks the conditions on the list that are relevant.

Another medical information card is disclosed by U.S. Pat. No. 5,171,039, issued on Dec. 15, 1992 to M. Dusek. This card is tailored to patients with a heart condition that might be indicated or illustrated by an electrocardiogram (EKG). The card is designed to contain the information of an EKG in the form of a short strip of the EKG curves.

Medical information cards such as these are useful for patients with specific medical conditions and needs. A patient's prescription medication status, however, may be subject to frequent change as old medications are discontinued, current medication dosages are changed, and new medications are prescribed. Without a system to insure that the patient's medical information card contains up-to-date prescription information, such a card is simply not helpful or reliable to provide prescription information.

Other medical information systems provide a patient with a card or other device that allows the patient's medical history and records to be carried in a computer- or machine-readable format. These systems are often intended to allow the patient information to be quickly downloaded into a computer system by emergency medical technicians or by hospital personnel. One such system is disclosed in U.S. Pat. No. 6,415,295, issued on Jul. 2, 2002 to L. Feinberg. A portable medical card is provided that includes the patient's medical information imprinted in a compressed, machine-readable format.

U.S. Patent Application Publication No. 2002/0097159, published on Jul. 25, 2002, discloses a system wherein personal medical information is stored in a computer microchip that may be contained in a patient-carried card or other device. The system includes a method of reading the computer microchip and transmitting the medical information to a hospital or other emergency medical treatment center.

Systems that employ a computer- or machine-readable medical history record that may be carried by a medical patient, or other persons, may provide a valuable or even life-saving function. The availability of medical information to an emergency treatment facility facilitates prompt and appropriate care. However, such systems overlook a basic need for patients to have a readily available and human readable account of their current prescriptions and medication status.

U.S. Patent Application Publication No. 2002/0128863 discloses a method and system for providing prescription drug coverage. This system uses a computer and database to track prescription information related to an employer-provided prescription drug benefit plan. The system utilizes a card for purchase and payment for prescription drugs. The card functions to provide payment information and information about the employer prescription drug benefit plan, but does not provide to an individual a readily available and human readable account of their current prescriptions and medication status.

None of the above inventions and patents, taken either singly or in combination, is seen to describe the instant invention as claimed. Thus a medical information card solving the aforementioned problems is desired.

### SUMMARY OF THE INVENTION

The present invention relates to a medical information card, and to a computerized system and method for providing the medical information card which assembles prescription information maintained by a pharmacy database, personal information provided by a pharmacy customer, and medical information provided by a physician or medical professional with the customer's new prescription order to format and print a human readable card with the medication and other medical information.

A pharmacy customer may enroll in the system by submitting personal enrollment information to the pharmacy, either by filling out and submitting a form to the pharmacy or, preferably, by entering enrollment information on an Internet Web page form. Enrollment information will include information about the customer such as the customer's name, address, contact information, and other basic identifying information. Additionally, the enrollment information may include medical information that is not likely to change, such as the name and phone numbers for the customer's primary care physician, and any known long-term medical conditions.

Once the customer is enrolled, any existing pharmacy database will be searched for current and historical information about prescription medications purchased from the pharmacy. This information is associated with the customer's enrollment information.

When the customer visits the pharmacy to obtain a prescription refill or a new prescription, information related to this change in the customer's prescription status is entered into the system, and a new medical information card is printed and delivered to the customer.

Additional information may be added by the customer or the customer's physician through an Internet Web page form. This additional information includes non-prescription medications, appointments and other date reminders, new doctors and their contact information, and more. The additional information will be formatted and printed on a new medical information card during the customer's next visit to the pharmacy.

Accordingly, it is a principal object of the invention to provide a system and method for providing a medical information card that includes an accurate and up-to-date list of prescription and other medications.

It is another object of the invention to provide a system and method for providing a medical information card wherein an accurate and up-to-date list of prescription and other medications is assembled from a database maintained by a pharmacy.

It is a further object of the invention to provide a system and method for providing a medical information card wherein a customer may use an Internet Web form to provide additional personal or medical information to be printed onto a medical information card.

Still another object of the invention is to provide a system and method for providing a medical information card wherein a customer's doctor may use an Internet Web form to provide additional personal or medical information to be printed onto a medical information card.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a front view of a medical information card according to the present invention.

FIG. 1B is a rear view of a medical information card according to the present invention.

FIG. 2 is a block diagram of a system for providing a medical information card according to the present invention.

FIG. 3 is a flow chart describing a method for providing a medical information card according to the present invention.

Similar reference characters denote corresponding features consistently throughout the attached drawings.

### DETAILED DESCRIPTION OF THE PREFERRED EMBODIMENT

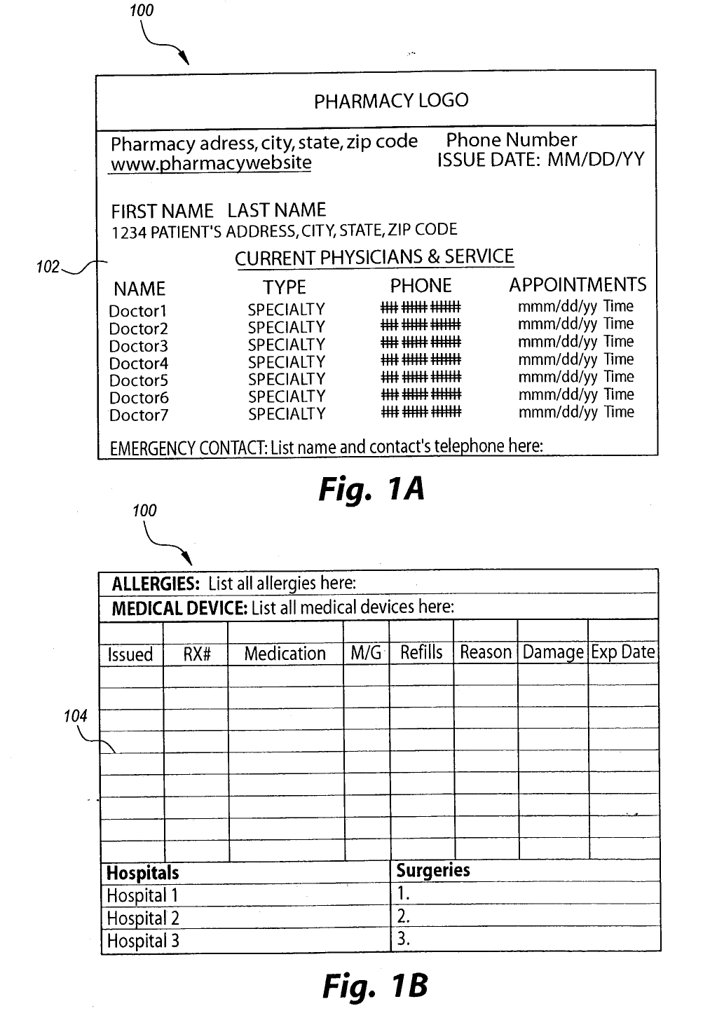

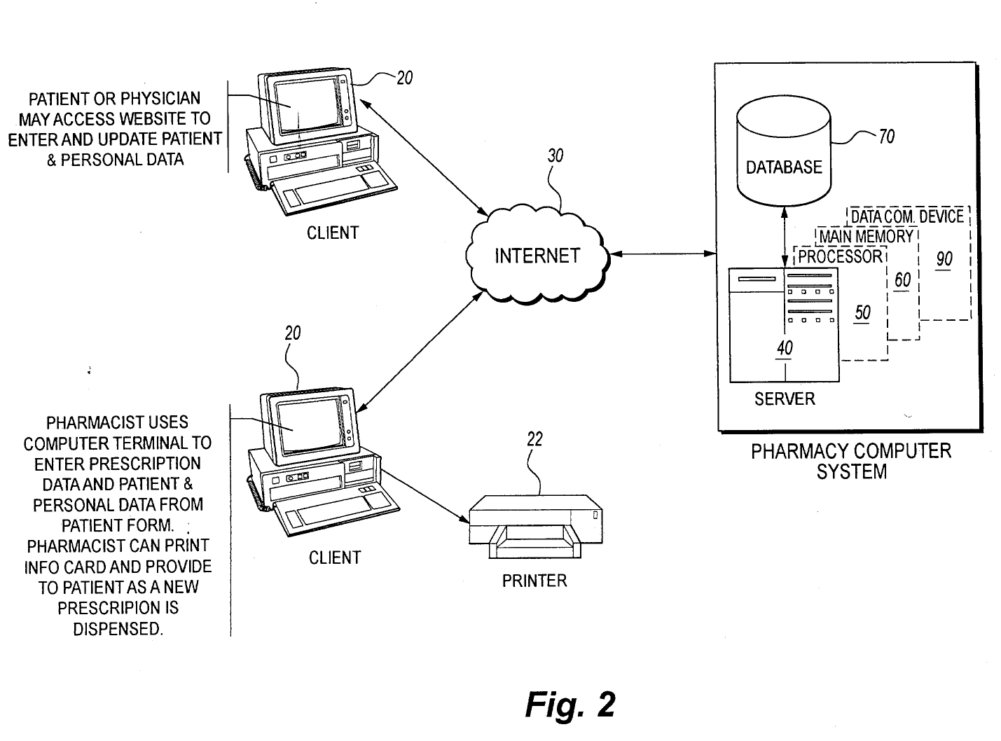

The present invention is a method and system for providing a medical information card. An exemplary medical information card 100 according to the present invention is shown in FIGS. 1A and 1B. In the sample shown, the medical information card 100 has a front side 102, shown in FIG. 1A, bearing a pharmacy logo and the pharmacy's address, telephone number, and website address, along with a patient's name and a list of the patient's current doctors and physicians and emergency contacts. The medical information card 100 has a back side 104, shown in FIG. 1B, bearing a list of, the patient's current prescription medications and a brief summary of other pertinent medical information. In an alternate embodiment, the patient's name, the list of current doctors and physicians and emergency contacts, the list of the patient's current prescription medications and the brief summary of other pertinent medical information are recorded on the medical information card 100 in a machine-readable format. The machine-readable format may be a printed bar code or a magnetic strip having the data magnetically stored thereon. The method and system for providing a medical information card 100 operates in a computerized system 10 as shown in FIG. 2. The computerized system 10 uses a client-server model, including a plurality of clients 20 connected to a server 40 through a computer network, preferably the Internet 30, although the computerized system 10 may operate on an intranet, an extranet, or another network environment. The server 40 has a processor 50 for processing instructions and an area of memory 60 for executing program code under the direction of the processor 50.

The computerized system 10 also includes at least one database 70 for storing data. The database 70 may reside in an area of disk storage on the server 40 and be connected to the main memory by a bus, or may reside on a remote database server accessible by the server 40, as is known in the art. A data communication device 90 is connected to the bus 80 for connection the 40 to the Internet 30. The client computers 20 have a Web browser or another network client software operable thereon for receiving and viewing documents written in Hypertext Markup Language (HTML) or another document format and transmitted over the Internet 30 via Hypertext Transfer Protocol (HTTP) by the server 40 and transmitting requests for HTML documents to the server 40 via HTTP.

The present invention includes software program code stored on a computer readable medium and operable in main memory 60 on the server 40 for providing a medical information card 100, which is accessible to a client computer 20 through the Internet 30. As used in the present application, the term “computer readable medium” refers to a hard disk drive, a floppy diskette, a ZIP disk or any other magnetic storage media capable of storing coded program instructions, an optical or laser storage device, such as a compact disk or laser disk, paper tape, punch cards, or any other media for the storage of program instructions readable by a storage device or reader. The computer code may be written in Java™ (Java is a trademark of Sun Microsystems) , HTML, XML, Microsoft's Active Server Pages (ASP) or any other Internet programming language known in the art, and includes code for creating and providing a medical information card 100.

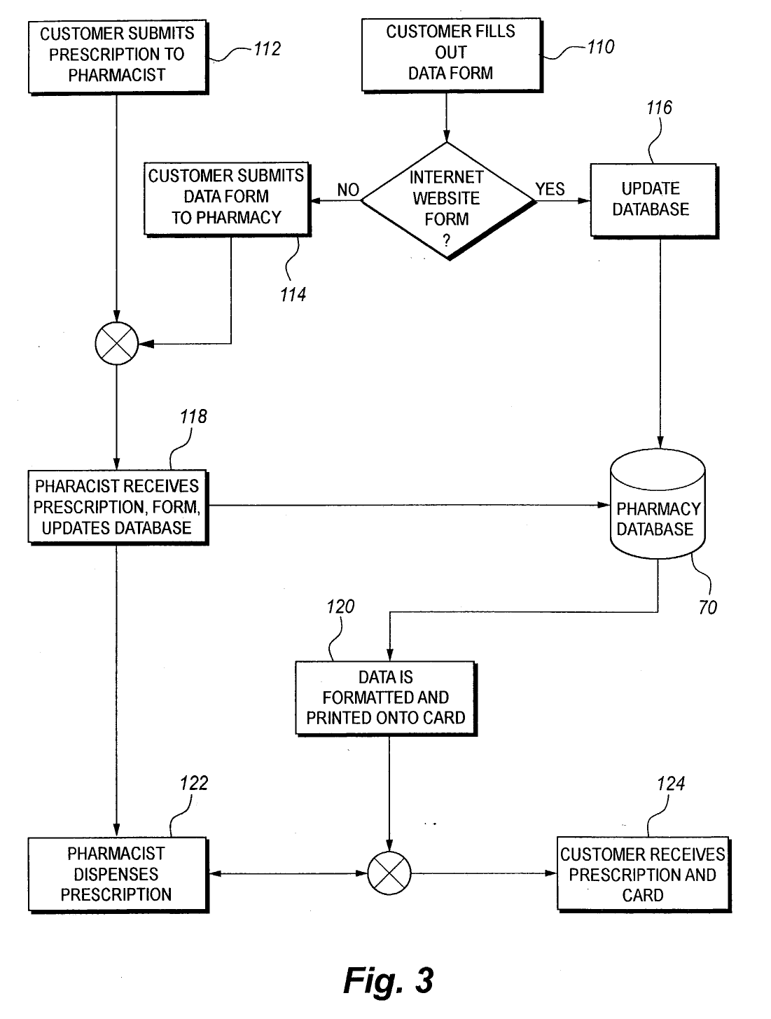

FIG. 3 is a flow chart of an embodiment of a method for producing a medical information card 100. The method includes a step of having a pharmacy customer provide the patient's personal information to be entered into a database, as indicated by block 110. The customer (the customer may be the patient, the patient's parent or guardian, etc.) provides personal identifying information that may be used to identify the patient's records in the database during future transactions. The customer may also provide medical summary information, summarizing aspects of the patient's medical history and record that are desired to be included on the medical information card 100. The customer provides this information either by filling out a paper form that will be submitted to the pharmacist for entry into the database, or by using a client computer 20 to access and fill out an Internet Web-based form. By using the Internet Web-based form, the information is entered directly into the database 70. In an exemplary embodiment, the patient's personal identifying information includes the patient's name and address. The patient's medical summary information includes items such as allergies, medical equipment and devices, doctors visited, surgical history and dates, hospital visits and reasons, and special transportation needs. The patient's personal identifying information is entered once to “enroll” the patient in the system, while the patient's medical summary information may be re-entered and updated as necessary.

When a patient has a new prescription to be filled, or a prescription to be refilled, the patient visits the pharmacy and submits the prescription or refill request to the pharmacist as indicated by block 112. If the patient chooses to enroll or update his medical summary information by using a paper form instead of using the Internet Web-based form, the customer submits the appropriate data form to the pharmacist as indicated by block 114. The pharmacist receives the prescription or refill request and enters the new prescription information, along with information from any form submitted by the customer, into the database 70 as indicated at block 118. The pharmacist uses a client computer 20 that is in communication with the server 50 to enter the information into the database 70. The prescription information includes the customer's name and address, the doctor's name and telephone number, the prescription number and issue date, the medication name and dosage, and the reason for the prescription. The patient's new prescription information is added to a patient prescription history log.

With the patient's new prescription entered, the new prescription information, the prescription history information and the medical summary information are retrieved from the database 70 and formatted for printing onto the medical information card 100. Block 120 indicates the data retrieval and printing. The pharmacist uses a client computer 20 with a printer 22 attached to request and print the medical information card 100. Once the medical information card 100 is printed, the pharmacist dispenses the prescription as indicated by block 122 and delivers the medical information card 100 to the customer. As indicated by block 124, the customer receives the prescription and medical information card 100 at the end of the transaction.

It is to be understood that the present invention is not limited to the embodiment described above, but encompasses any and all embodiments within the scope of the following claims.

I claim:

1. A computerized system for providing a medical information card, comprising:
at least one server computer having a processor, an area of main memory for executing program code under the direction of the processor, a storage device for storing data and program code and a bus connecting the processor, the main memory, and the storage device;
at least one database stored on said storage device;
a data communications device connected to said bus for connecting said server computer to the Internet; and
a computer program stored in said storage device and executing in said main memory under the direction of said processor, the computer program including:
means for inputting a patient's personal identifying information and entering the patient's personal identifying information into a database;
means for inputting the patient's medical summary information from a customer and entering the patient information into a database;
means for inputting the patient's new prescription information and entering the new prescription information into the database;
means for adding the patient's new prescription information into a patient prescription history log;
means for recalling the patient's personal identifying information, the patient's medical summary information, the patient's new prescription information, and the patient's prescription history log from the database;
means for formatting the patient's medical summary information, the patient's new prescription information, and the patient's prescription history log for printing onto a medical information card; and
printing means for printing the formatted customer's medical summary information, the customer's new prescription information, and the customer's prescription history log for printing onto a medical information card.

2. The computerized system for providing a medical information card of claim 1, wherein said printing means further comprises means for printing the formatted patient's medical summary information, the patient's new prescription information, and the patient's prescription history log for printing onto a medical information card in a machine readable format.

3. A computer program product that includes a medium readable by a processor, the medium having stored thereon a set of instructions comprising:
a first sequence of instructions which, when executed by the processor, causes the processor to input a patient's personal identifying information and enter the patient's personal identifying information into a database;
a second sequence of instructions which, when executed by the processor, causes the processor to input the patient's medical summary information from a customer and enter the patient information into a database;
a third sequence of instructions which, when executed by the processor, causes the processor to input the patient's new prescription information and enter the new prescription information into the database;
a fourth sequence of instructions which, when executed by the processor, causes the processor to add the patient's new prescription information into a patient prescription history log;
a fifth sequence of instructions which, when executed by the processor, causes the processor to recall the patient's personal identifying information, the patient's medical summary information, the patient's new prescription information, and the patient's prescription history log from the database;
a sixth sequence of instructions which, when executed by the processor, causes the processor to format the patient's medical summary information, the patient's new prescription information, and the patient's prescription history log for printing onto a medical information card; and
a seventh sequence of instructions which, when executed by the processor, causes the processor to print the formatted patient's medical summary information, patient's new prescription information, and patient's prescription history log onto a medical information card.

4. A computerized method for providing a medical information card, comprising the steps of:
inputting a patient's personal identifying information and entering the patient's personal identifying information into a database;
inputting the patient's medical summary information from a customer and entering the patient's information into a database;
inputting the patient's new prescription information and entering the new prescription information into the database;
adding the patient's new prescription information into a patient prescription history log;
recalling the patient's personal identifying information, the patient's medical summary information, the patient's new prescription information, and the patient's prescription history log from the database;
formatting the patient's medical summary information, the patient's new prescription information, and the patient's prescription history log for printing onto a medical information card; and
printing the formatted patient's medical summary information, the patient's new prescription information, and the patient's prescription history log for printing onto a medical information card.

5. The computerized method for providing a medical information card of claim 4, wherein the step of inputting a patient's personal identifying information further comprises the steps of:
inputting the patient's name; and
inputting the patient's address.

6. The computerized method for providing a medical information card of claim 4, wherein the step of inputting a patient's medical summary information further comprises the steps of:
inputting the patient's allergies;
inputting the patient's medical equipment and devices;
inputting the patient's doctor names and telephone numbers;
inputting the patient's surgical history and dates;
inputting the patient's hospital visits and reasons; and
inputting the patient's special transportation needs.

7. The computerized method for providing a medical information card of claim 4, wherein the step of inputting a patient's new prescription information further comprises the steps of:
inputting the patient's name and address;
inputting the prescribing doctor's name and telephone number;
inputting the prescription number and the prescription issue date;
inputting the medication name and dosage; and
inputting the reason for the prescription.
